(19) United States
(12) Patent Application Publication
(10) Pub. No.: US 2026/0231072 A1
(43) Pub. Date: Aug. 6, 2026

(54) TIMING ADVANCE IN DISCONNECTED MODE

(71) Applicant: Sony Group Corporation, Tokyo (JP)

(72) Inventors: Basuki PRIYANTO, Lund (SE); Anders BERGGREN, Lund (SE); Nafiseh Seyed MAZLOUM, Lund (SE); Torgny PALENIUS, Barsebäck (SE)

(21) Appl. No.: 19/152,771

(22) PCT Filed: Feb. 15, 2024
(86) PCT No.: PCT/EP2024/053910

§ 371 Date: Jul. 31, 2025

(30) Foreign Application Priority Data
Feb. 16, 2023 (SE) 2350170-3

(51) Int. Cl. H04W 56/00; H04W 52/02; H04W 76/27

(52) U.S. Cl. CPC H04W 56/0045; H04W 52/0216; H04W 56/006; H04W 76/27

(57) ABSTRACT

A wireless communication device (101) determines a timing advance for facilitating communication with each of one or more base stations (74-79, 112, 113) of a cellular network (100) based on timing measurements on one or more downlink reference signals (4145) transmitted by each of the one or more base stations while the wireless communication device (101) operates in a disconnected mode. The timing advance is associated with a spatial context (80).

### TECHNICAL FIELD

Various examples generally pertain to a wireless communication device determining a timing advance while operating in a disconnected mode.

### BACKGROUND

A wireless communication device (UE) that can connect to a cellular network (NW) can be positioned based on uplink (UL) reference signals (RSs) that are transmitted by the UE and received by multiple base stations (BSs). Then, multi-angulation can be performed to determine the position of the UE.

Typically, the UE transmits the UL reference signals when operating in a connected mode during which a data connection between the UE and the radio-access network of the cellular NW is established.

The Third Generation Partnership Project (3GPP) Technical Specification (TS) 38.214, version 17.4.0, section 6.2.1 describes UL Sounding RS (SRS) transmission while the UE operates in the RRC_Connected mode.

The position of a UE operating in a disconnected mode (such as an inactive mode or idle mode) is required for some applications/use-cases.

According to reference implementations, the UE performs periodic transmission of UL SRS while operating in the disconnected mode. The UE is configured with respective time-frequency resources while operating in the connected mode and prior to transitioning to operating in the disconnected mode, e.g., in a Radio Resource Control (RRC) release message. The UE uses this configuration for the transmission of periodic transmission of UL SRS while the UE is in RRC_Inactive mode for positioning purposes. See TS 38.214, version 17.4.0 (2022-12), section 6.2.1.4.

It has been found that such reference implementations are associated with significant UE power consumption. Another constraint is that the reference implementation does not support mobility. Once the UE moves to another cell of the cellular NW, then the UL SRS configuration of the previous cell is no longer valid. The UE needs to re-acquire the UL SRS configuration of a new cell meaning the UE needs to enter connected mode. This consumes significant power.

A 3GPP Rel-18 work item on Expanded and Improved NR Positioning has been approved in 3GPP RAN#98e See 3GPP RP-223549. One of the objectives is to specify enhancements for enabling low power high accuracy positioning (LPHAP) use-case 6 as defined in 3GPP TS 22.104 including: For UL, and downlink (DL) and UL positioning for UEs in RRC_INACTIVE state, specifying SRS configuration enhancements based on SRS positioning validity area to avoid frequent RRC connection for SRS (re)configuration. SRS for positioning configurations in multiple cells. Pre-configuration of one or multiple SRS for positioning configurations. SRS for positioning activation/request procedure(s). Specifying corresponding new core requirements, as well as identifying and specifying the impact on the existing specification, including Radio Resource Management (RRM) measurements and procedures.

### SUMMARY

A need exists for advanced techniques of enabling a UE to transmit UL RSs while operating in a disconnected mode. A need exists for advanced techniques of positioning a UE while operating in a disconnected mode.

This need is met by the features of the independent claims. The features of the dependent claims define embodiments.

A method for use in a UE is disclosed. The UE can connect to a cellular NW. The method includes determining a timing advance for facilitating communication with one or more BSs. The one or more BSs are part of the cellular NW. The timing advance is determined while operating in a disconnected mode. The timing advance is determined based on timing measurements.

The timing measurements are on one or more DL reference signals. The one or more DL reference signals are transmitted by each of the one or more BSs. The method further includes transmitting UL reference signals. The UL reference signals are transmitted in accordance with the timing advance. The UL reference signals are transmitted in preconfigured time-frequency resources. The UL reference signals are transmitted upon determining that the UE is situated in a predefined spatial context. The UL reference signals are transmitted while operating in the disconnected mode.

A UE is disclosed. The UE can connect to a cellular NW. The UE includes at least one processor and memory. The at least one processor is configured to load program code that is stored in the memory. The at least one processor is configured to execute the program code. The at least one processor, upon loading and executing the program code, is configured to determine a timing advance for facilitating communication with one or more BSs. The one or more BSs are part of the cellular NW. The timing advance is determined while operating in a disconnected mode. The timing advance is determined based on timing measurements. The timing measurements are on one or more DL reference signals. The at least one processor is further configured to transmit UL reference signals. The UL reference signals are transmitted in accordance with the timing advance. The UL reference signals are transmitted in preconfigured time-frequency resources. The UL reference signals are transmitted upon determining that the UE is situated in a predefined spatial context. The UL reference signals are transmitted while operating in the disconnected mode.

A method for use in a node of a cellular NW is disclosed. The method includes providing at least one configuration message to a UE. The at least one configuration message is associated with the UE determining a timing advance for a transmission of UL reference signals based on timing measurements that are based on DL reference signals. The DL reference signals are transmitted by one or more BSs of the cellular NW. The method also includes triggering the one or more BSs to monitor for the UL reference signals that are transmitted by the UE while operating in a disconnected mode.

The node may be a BS of the cellular NW. Alternatively or additionally, the node may be a positioning server of the cellular NW.

A node of a cellular NW is disclosed. The node includes at least one processor and a memory.

The at least one processor is configured to load program code from the memory and to execute the program code. The at least one processor, upon loading and executing the program code, is configured to provide at least one configuration message to a UE. The at least one configuration message is associated with the UE determining a timing advance for a transmission of UL reference signals based on timing measurements that are based on DL reference signals. The DL reference signals are transmitted by one or more BSs of the cellular NW. The at least one processor is further configured to trigger the one or more BSs to monitor for the UL reference signals that are transmitted by the UE while operating in a disconnected mode.

A method for use in a positioning server of a cellular NW is disclosed. The method includes obtaining, from one or more BSs of the cellular NW, an indication of the one or more BSs supporting a UE operating in a disconnected mode to transmit UL reference signals in accordance with a timing advance. The timing is advance is determined by the UE. The method also includes configuring the UE to transmit the UL reference signals when operating in the disconnected mode.

A positioning server of a cellular NW is disclosed. The positioning server includes at least one processor and a memory. The at least one processor is configured to load program code from the memory and to execute the program code. The at least one processor, upon loading and executing the program code, is configured to obtain, from one or more BSs of the cellular NW, an indication of the one or more BSs supporting a UE operating in a disconnected mode to transmit UL reference signals in accordance with a timing advance. The timing advance is determined by the UE. The method also includes configuring the UE to transmit the UL reference signals when operating in a disconnected mode.

Computer programs are disclosed that include program code that can be loaded and executed by at least one processor. The at least one processor, upon executing the program code, performs methods as disclosed above.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a cellular NW according to various examples.

FIG. 2 schematically illustrates a UE according to various examples.

FIG. 3A schematically illustrates a BS according to various examples.

FIG. 3B schematically illustrates a location server according to various examples.

FIG. 4 is a flowchart of a method for use in the UE according to various examples.

FIG. 5 is a flowchart for use in the BS according to various examples.

FIG. 6 is a flowchart for use in a positioning server according to various examples.

FIG. 7 schematically illustrates a spatial context according to various examples.

FIG. 8 is a signaling diagram according to various examples.

FIG. 9 is a signaling diagram according to various examples.

FIG. 10 is a signaling diagram according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the ac-companying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Aspects with respect to operating a UE connectable to a cellular NW are disclosed. Specifically, aspects of operating the UE in a disconnected mode are disclosed.

The disconnected mode can be the RRC_Inactive or RRC_Idle mode according to 3GPP TS 38.331, Version 17.2.0, section 4.2.1. A data connection between the cellular NW and the UE is not maintained while the UE operates in the disconnected mode. The disconnected mode is different than a connected mode in which the data connection is maintained between the UE and the cellular NW.

According to techniques disclosed herein the UE transmits UL RSs while operating in the disconnected mode. The UL reference signals can be SRS, particularly SRS for positioning purposes. By being allowed to transmit the UL reference signals while operating in the disconnected mode, frequent changes from the disconnected mode to the connected mode can often be avoided. Thereby, the power consumption at the UE can be reduced.

According to the techniques disclosed herein, the UE transmits UL reference signals while operating in the disconnected mode; the UE is allowed to transmit the UL reference signals taking into account mobility of the UE. This is in contrast to implementations in the prior art where the UE is only allowed to transmit UL reference signals with zero mobility, i.e., while and as long as the UE remains stationary. According to various examples, the amount of mobility of the UE is regulated. For this purpose, certain procedures are linked and limited to a certain spatial context. As long as the UE is situated in the spatial context, the UE is allowed to transmit UL reference signals. The UL reference signals can be transmitted on preconfigured time-frequency resources that are allocated for positioning of the UE. In other words, based on the UL reference signals, the UE can be positioned. Positioning measurements can be executed by one or more BSs of the cellular NW receiving the UL reference signals and based on these positioning measurements the UE can then be positioned e.g., by a positioning server of the cellular NW.

Hereinafter, various examples will be disclosed in the context of employing the UL RSs transmitted by the UE while operating in the disconnected mode for positioning; however, the UL RSs can also be transmitted for other purposes than positioning, e.g., channel sounding.

The transmitting of the UL reference signals is synchronized with a timing reference of the cellular NW. A BS of the cellular NW is expected to receive any signals from one or more UEs that may be located in different locations within coverage of a cell in accordance with that timing reference. To achieve this, a UE compensates for the over-the-air propagation delay of signals. A time offset is applied, referred to as timing advance (TA). A UE that is located far away from a BS needs to transmit signals earlier than the UE that is located closer to the same BS so that the signals arrive at the same point in time at the BS. Accordingly, the far-way UE applies a larger TA (i.e., the timing compensation value used by the UE has a larger magnitude) while the UE that is closer to the BS applies a comparatively small TA (i.e., the timing compensation value used by the UE has a smaller magnitude). The TA controls UL transmission timing of individual UE. TA helps to ensure that UL transmissions from a UE are synchronized when received by the BS. For a given position of the UE in the coverage of the cellular NW, each BS is associated with a respective TA from the perspective of the UE (because the distance to each BS is different).

According to reference implementations, see 3GPP TS 38.321, version 17.2.0, section 5.2, the TA is obtained during a random access (RACH) procedure. According to reference implementations, the UE transmits a RACH preamble, the BS calculates the TA, then BS provides the TA to the UE via the response message. According to reference implementations, the UE will use the TA for subsequent transmissions. According to reference implementations, in case the UE is configured for UL SRS transmissions in RRC_Inactive mode, the UE uses the TA value obtained while in connected mode when transmitting the UL SRS in RRC_Inactive mode. The TA value is thus related to the serving cell that the UE was released from.

Various techniques are based on the finding that obtaining the TA by performing a RACH procedure is consuming power at the UE. According to various examples, determining of TA and obtaining of UL SRS configuration including the UL SRS time-frequency resources and spatial direction (i.e., beam direction) from the BS(s) enables a comparatively lower power consumption.

According to various examples, a UE transmits UL SRS based on a TA that is calculated at the UE. According to various examples, the UE transmits the UL SRS on pre-configured UL time-frequency resources in accordance with the TA. The UE does not need to transition to the connected mode to determine the TA. This saves power at the UE.

According to examples, use of a locally determined TA is restricted to a certain spatial context.

According to examples, the TA is accordingly associated with a spatial context. According to examples, such determining of the TA at the UE based on timing measurements executed by the UE based on DL reference signals that are received by the UE while the UE operates in the disconnected mode is restricted to a certain spatial context. The spatial context defines a geographical area or region within which the UE is allowed to determine the TA as outlined above.

By restricting the determining of the TA at the UE to the spatial context, general interference of the UE with communication on the cellular NW outside of the spatial area is avoided; in particular, there is a risk that the UE miscalculates the TA and such miscalculation has the potential of interference with other communication on the cellular NW.

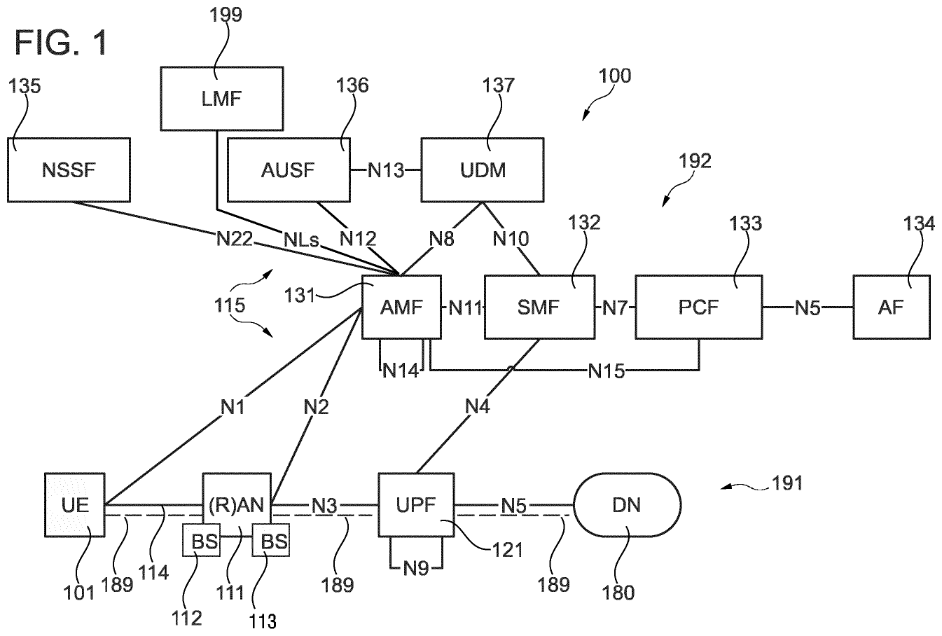

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, version 17.0.0 (2021-03-30).

In the scenario of FIG. 1, a UE 101 is connectable to the cellular NW 100. For example, the UE 101 may be one of the following: a cellular phone; a smart phone; an Internet of Things device; etc.

The UE 101 is connectable to the NW 100 via a RAN 111, typically formed by one or more BSs 112, 113. The BSs 112, 113 are also labeled “gNBs” in 3GPP NR. A wireless link 114 between the RAN 111 and the UE 101 is illustrated.

The RAN 111 is connected to a core NW (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW (DN) 180, e.g., the Internet or a Local Area NW. Application data can be communicated between the UE 101 and one or more servers on the DN 180.

The CN 115 of the cellular NW 100 also includes an Access and Mobility Management Function (AMF) 131 implementing a mobility control node; a Session Management Function (SMF) 132; a Policy Control Function (PCF) 133; an Application Function (AF) 134; a NW Slice Selection Function (NSSF) 135; an Authentication Server Function (AUSF) 136; a Unified Data Management (UDM) 137; and a Location Management Function (LMF) 199 implementing a location control node. FIG. 1 also illustrates the protocol reference points N1-N22 between these nodes. A data connection 189 is established between the UE 101 and the userplane 191 of the CN 115 and towards the DN 180 via the RAN 111. For example, a connection with the Internet or another packet data NW can be established. To establish the data connection 189, it is possible that the respective UE 101 performs a RACH procedure. The data connection 189 may include one or more bearers such as a dedicated bearer or a default bearer. The data connection 189 can carry application data. When the data connection 189 is not established or used between the UE 101 and the RAN 111, the UE 101 operates in a disconnected mode. Examples are RRC_Inactive and RRC_Idle.

A positioning server implemented by the LMF 199 handles positioning of the UE 101. This may include transferring assistance data to the target UE 101 to be positioned to assist with UE-based and/or UE-assisted positioning and/or may include positioning of the target UE. See 3GPP TS 38.305 V17.2.0 (2022-12), section 5.1.

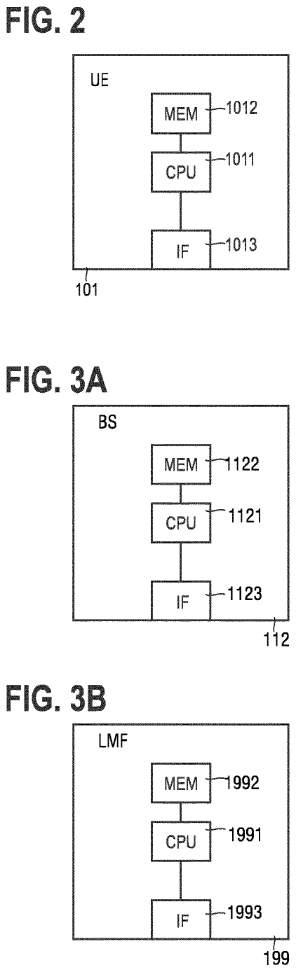

FIG. 2 schematically illustrates details with respect to the UE 101. The UE 101 includes a processor 1011 and a memory 1012. Program code is stored in the memory 1012. The processor 1011 can load program code and execute the program code. Upon loading and executing the program code, the processor performs techniques as disclosed herein, e.g.: communicating via a communication interface 1013 on the wireless link 114, e.g., with the BS 112 or the BS 113; obtaining messages from the cellular NW 100, e.g., from the LMF 199; transitioning between operation in a connected mode and in a disconnected mode; performing a RACH procedure, e.g., at least partly until obtaining a TA; determining a TA for each of multiple BS; transmitting UL reference signals while operating in the disconnected mode based on the TA; etc.

FIG. 3A schematically illustrates details with respect to the BS 112. While FIG. 3A illustrates the BS 112, the BS 112 can be configured similarly. The BS 112 includes a processor 1121 and a memory 1122. Program code is stored in the memory 1122. The processor 1121 can load the program code and execute the program code. Upon loading and executing the program code, the processor 1121 performs techniques as disclosed herein, e.g.: communicating via the communication interface 1123 on the wireless link 114, e.g., with the UE 101; communicating via the communication interface 1123 with other nodes of the cellular NW; obtaining messages from other nodes of the cellular NW, e.g., from the LMF 199; providing messages to other nodes of the cellular NW, e.g., to the LMF 199; providing messages or obtaining messages to or from the UE 101; transmitting DL reference signals; monitoring for UL reference signals transmitted by the UEs 101 while operating in the disconnected mode; etc.

FIG. 3B schematically illustrates details with respect to the LMF 199. The LMF 199 includes a processor 1991 and a memory 1992. Program code stored in the memory 1992. The processor 1991 can load the program code and execute the program code. Upon loading and executing the program code, the processor 1991 performs techniques as disclosed herein, e.g., communicating via the communication interface 1993, with other nodes of the cellular NW such as the BSs 112, 113 or with the UE 101; determining a position/location of the UE 101 based on positioning measurement reports obtained from multiple BSs; providing a configuration for transmitting UL reference signals to a UE; etc.

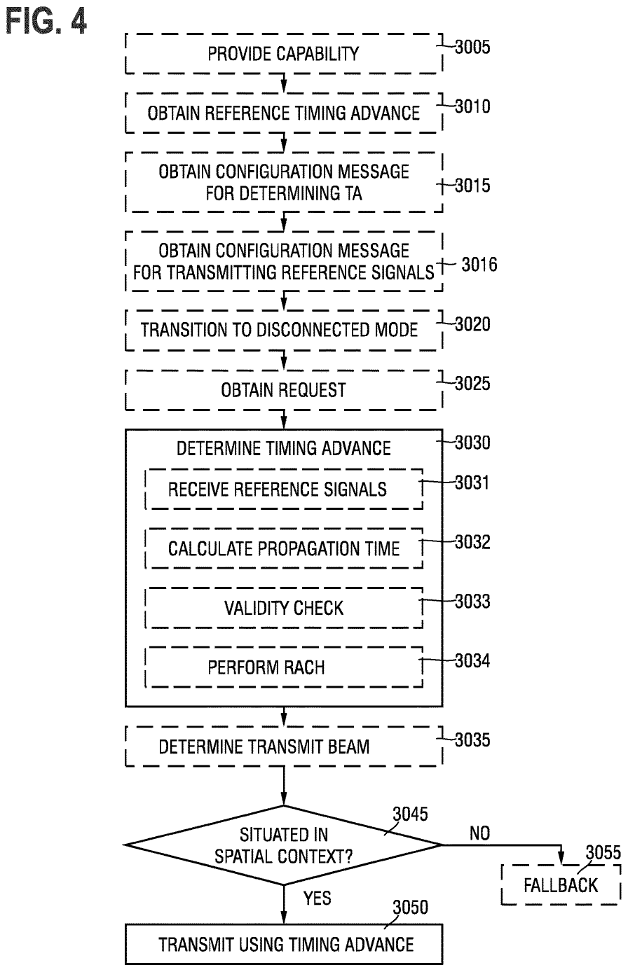

FIG. 4 is a flowchart of a method according to various examples. The method of FIG. 4 is for use in a UE. The UE is connectable to a cellular NW. For example, the method of FIG. 4 can be used by the UE 101. More specifically, the method of FIG. 4 can be executed by the processor 1011 based on program code that is stored in the memory 1012 and then loaded and executed by the processor 1011.

Optional boxes are labeled with dashed lines.

At optional box 3005, the UE can provide, to the cellular NW, an indication that the UE is capable of determining the TA based on timing measurements on one or more DL reference signals that are transmitted by each of one or more BSs of the cellular NW.

The UE can provide an RRC control message that is indicative of its capability while operating in a connected mode.

At optional box 3010, the UE optionally obtains a reference TA from the cellular NW.

For instance, the serving BS of the cellular NW-while the UE operates in a connected mode can provide an indication of the reference TA. The reference TA can be included in an RRC connection release message that triggers a transition of the UE from operating in the connected mode to operating in a disconnected mode. The reference TA can be obtained as part of a con-figuration message that is associated with determining the TA locally at the UE.

Alternatively or additionally to obtaining a reference TA at box 3010, it would also be possible that an allowed range of a TA that is determined at the UE is indicated. Such allowed range can specify an upper bound and/or a lower bound of TAs. Alternatively or additionally to obtaining a reference TA or an allowed range, it would be possible that candidate values of TAs are obtained. For instance, an array of candidate values can be obtained. The candidate values can be indicated by a reference and a step size.

Alternatively or additionally to obtaining a reference TA at box 3010. The reference TA is obtained using the legacy method, for example, when the TA is obtained by the UE in the registration process (e.g., after booting up the UE). The reference TA can be obtained when the UE operates in the connected mode.

Such information regarding constraints and/or references associated with determining a TA at the UE are guidance provided by the cellular NW to the UE to facilitate the determination of the TA at the UE.

Such information can be provided for each of multiple BSs in a certain spatial context in which the UE is allowed to determine the TA based on timing measurements executed at the UE.

While FIG. 4 illustrates box 3010 to be separate from box 3015, it would be possible that the reference TA and/or candidate values of the TA and/or an allowed range of the TA are obtained as part of the at least one configuration message obtained at box 3015.

At box 3015, at least one configuration message is optionally obtained. The at least one configuration message is associated with determining a TA at the UE. The at least one configuration message of box 3015 can be provided by the RAN of the cellular NW. For instance, a BS of the radio-access NW of the cellular NW can generate and provide the at least one configuration message.

In some examples, a single configuration message is obtained. The single configuration message can include one or more of the parameters listed below as examples. In further examples, it would be possible that multiple configuration messages are obtained, e.g., at different points in time. It would even be possible that at least one of the multiple configuration messages is obtained by the UE when operating in the connected mode; and another at least one of the multiple configuration messages is obtained by the UE when operating in the disconnected mode (FIG. 4 illustrates an example where the UE transitions to the disconnected mode at box 3020). The at least one configuration message of box 3015 can be indicative of a spatial context. The spatial context is, in other words, associated with a geographical area. Only if the UE is situated in the spatial context, the UE is allowed to determine the TA based on timing measurements. There are various options available for defining the spatial context. In one example, the spatial context can be defined such that the UE is required to be located in one or more cells of the cellular NW. Accordingly, the at least one configuration message obtained at box 3015 could include a list of cell identities.

In one example, alternatively or additionally, the spatial context is defined by the UE being located in the geographical area that is defined by a geofenced area. The geofenced area can include multiple nodes-e.g., at certain latitude and longitude-that define a polygon outline of the geofenced area. The at least one configuration message can then indicate the geofenced area.

In one example, alternatively or additionally, the predefined spatial context is defined by the UE being able to receive DL reference signals transmitted by the cellular NW. The reference signals can have certain identities. The reference signals can include such identities. The reference signals can also be identified by certain time-frequency resources on which they are transmitted.

Examples would be synchronization signal blocks (SSBs) that are transmitted by the BSs of the cellular NW. The at least one configuration message can then indicate the DL RSs.

According to examples, the UE performs measurements on DL reference signals. For instance, a received signal strength can be determined. It is then possible to compare one or more receive properties—e.g., received signal strength—with one or more predefined thresholds. Any detected DL reference signal that passes the threshold comparison is considered to be received by the UE and thus considered in connection with determining whether the UE is situated in the predefined spatial context.

Various such options for defining the spatial context can be combined with each other to form further scenarios.

As a general rule, the cellular NW may broadcast whether the UE is allowed or not to self-calculate the TA. If allowed, whether to use PRS or SSB. Specifically, the at least one configuration message obtained at box 3015 is, in some examples, indicative of whether the UE is allowed to employ the TA determined based on the timing measurements that are based on the DL reference signals. In other words, the at least one configuration message can activate the UE using a locally-calculated TA for transmitting of UL reference signals.

The at least one configuration message obtained at box 3015 is, in some examples, indicative of a calculation rule for determining the TA based on the timing measurements that are based on the DL reference signals. The calculation rule can specify how many timing measurements are to be executed. The calculation rule can specify a time offset between subsequent timing measurements. The calculation rule can specify how to take into account a reference TA and/or candidate values of the TA and/or an allowed range of a TA, e.g., as obtained at box 3010.

The at least one configuration message obtained at box 3015 is, in some examples, indicative of the type of the one or more DL reference signals. It can, accordingly, specify which particular DL reference signals to use, e.g., whether to use SSBs or channel state information reference signals (CSI-RSs) etc. The at least one configuration message obtained at box 3015 can indicate time-frequency resources of the DL RSs to be used by the UE to determine the TA.

At box 3016, at least one configuration message associated with transmitting of UL reference signals is obtained. This is generally optional: in other scenarios, the UE can be preconfigured accordingly. In such a scenario, the configuration is already available at the UE.

In some examples, the at least one configuration message is obtained from a positioning server such as the LMF 199. The serving BS or/and each neighbor BS can provide respective information regarding the transmitting of UL RSs to the positioning server; and the positioning server can then provide the at least one configuration message to the UE.

The at least one configuration message of box 3016 can be provided by a positioning server of the cellular NW. If multiple configuration messages are obtained at box 3016, at least one of those multiple configuration messages can be provided by the positioning server. The at least one configuration message of box 3016 can be partly provided by a radio-access NW of the cellular NW. If multiple configuration messages are obtained at box 3016, at least one of those multiple configuration messages can be provided by the radio-access NW.

While in the scenario of FIG. 4 the at least one configuration message is provided before transitioning to operation in the disconnected mode—i.e., prior to box 3020—it would also be possible that the at least one configuration message is provided after transitioning to the disconnected mode, i.e., after to box 3020.

The properties of the pre-configuration of the UL RSs can include specific parameters such as association of SRS resources and SSB resources. A dedicated UL-SRS to be used by the UE can be configured. Other UEs are prevented from using these SRS resources.

The configuration message can select one set of configuration parameters from multiple candidate sets pre-configured at the UE. The configuration message can include a respective pointer to the selected set of configuration parameters.

The at least one configuration message obtained at box 3016 can be indicative of the preconfigured time-frequency resources. The preconfigured time-frequency resources can be explicitly specified or can be implicitly specified. For instance, scheduling information can be provided.

The at least one configuration message obtained at box 3016 can be indicative of a frequency start position of preconfigured time-frequency resources for transmitting UL reference signals.

The frequency start position can be indicated as a lower bound of a band. The frequency start position can be indicated as a lower bound of one or more subcarriers.

The at least one configuration message obtained at box 3016 can be indicative of a bandwidth of the preconfigured time-frequency resources. The bandwidth can be indicated by a count of subcarriers. The bandwidth can be indicated by a certain bandwidth part.

The at least one configuration message obtained at box 3016 can be indicative of a frequency stop position of the preconfigured time-frequency resources. The frequency stop position can be indicated as an upper bound of a band. The frequency stop position can be indicated as an upper bound of one or more subcarriers.

The at least one configuration message obtained at box 3016 can be indicative of a numerology of the preconfigured time-frequency resources. See, e.g., 3GPP TS 38.211, version 17.2.0, Table 4.2-1. A subcarrier spacing is thereby indicated.

The at least one configuration message obtained at box 3016 can be indicative of a count of repetitions of preconfigured time-frequency resources. For instance, each repetition can include one or more time-frequency resources in a certain time slot.

The at least one configuration message obtained at box 3016 can be indicative of a repetition rate of the preconfigured time-frequency resources. The time-frequency resources can be repetitive, i.e., reoccur from time to time. The repetition rate specifies how often they reoccur. For instance, every n-th subframe or timeslot can include such resources.

The at least one configuration message obtained at box 3016 can be indicative of a comb size of the preconfigured time-frequency resources. The comb-size can specify a frequency offset of a frequency pattern of the time-frequency resources.

The at least one configuration message obtained at box 3016 can be indicative of an association of the pre-configured time-frequency resources with further time-frequency resources on which the DL reference signals are transmitted. For instance, the time-frequency resources can be relatively defined with respect to the further time-frequency resources, e.g., by a time offset and/or a frequency offset.

The at least one configuration message obtained at box 3016 can be indicative of signal characteristics of the UL reference signals. For instance, they may specify identities to be used for the UL reference signals. They may specify a certain scrambling code. They may specify a sequence design.

The at least one configuration message obtained at box 3016 can be indicative of a spatial relationship of the UL reference signals. For instance, certain beams can be indicated. Beamforming parameters of transmitting of the UL reference signals can be indicated.

In a first example, the UE is pre-configured with the specific spatial direction behavior for transmitting the UL RSs, such as BS SRS reception behavior. In this case, there can be an association between SSB resources and UL-SRS resources. This association can be different for each BS towards which the UE transmits the UL RSs. Here, the UE performs the legacy SSB measurements for multiple cells. Once the UE has identified the best spatial direction of the received SSB, the UE is expected to use the same beam for the UL RS transmission.

In a second example, the UE also performs SSB measurements but only for the serving cell.

Hence, the association between SSB and UL RSs resources is only for the serving cell.

In a third example, the UE is not provided with the spatial direction information. Here, the UE only knows the resources to transmit SRS. It is up to the UE to use the spatial direction for UL SRS transmission.

The UE can be configured by indicating time/frequency resources of the UL-SRS, UL-SRS signal characteristics, such as sequence ID, spatial relation of the UL-SRS, and/or TA parameters (step-size, maximum value).

Above, various parameters and information elements that can be indicated by the at least one configuration message obtained at box 3016 have been disclosed.

There can be a common and cell-specific UL RS configuration that is used by each BS. Common parameters mean that multiple BSs share the same parameters. For example, common parameters can be RS frequency start, RS bandwidth, RS numerology (carrier spacing), repetitions, comb size, etc. Cell-specific parameters are not shared between different BSs.

According to examples, the at least one configuration message associated with the transmitting of the UL reference signals is indicative of one or more share parameters that are jointly set for transmitting the UL reference signals towards different ones of the multiple BSs of the cellular NW. In other words, it would be possible that, e.g., certain properties of the time-frequency resources are shared between multiple BSs of the cellular NW. In such a case, the at least one configuration message obtained at box 3016 can include an information element that is indicative of such sharing of the information. Then, the at least one configuration message does not include duplicates of such information for the different BSs.

The at least one configuration message obtained at box 3016 can be indicative of one or more cell-specific parameters that are individually set for transmitting the UL reference signals towards different ones of the multiple BSs of the cellular NW. For example, it is possible that different cells use different time-frequency resources so that the UE transmits the UL reference signals at respective different instances towards different BSs. Cell-specific parameters can be, e.g., association of SRS resources and SSB resources.

Above, scenarios have been disclosed in which the at least one configuration message obtained at box 3016 indicates one or more parameter values. These parameter values can be explicitly indicated, e.g., as numerical values and respective fields of the at least one configuration message. It would also be possible to indicate such parameter values implicitly. For instance, a pointer to pre-configured parameter values (e.g., pre-configured by the positioning server) can be provided, e.g., by the BS or BSs. There can be multiple sets of UL RSs configurations in a UE, e.g., provided by the positioning server. The BS—e.g., the serving BS—can inform the UE on the selected configuration when the BS trigger the UE to transmit UL SRS. Thus, in an example, the positioning server pre-provisions multiple candidate configurations; and the BS selects the actual configuration from amongst these candidate configurations.

The UE, at box 3020, transitions to a disconnected mode. This means that a data connection is released or suspended or paused. In the disconnected mode the UE does not maintain an active data connection towards the cellular NW. For example, the connected mode can be RRC_Connected; for example, the disconnected mode can be RRC_Inactive or RRC_Idle.

In some scenarios, it would be possible that a connection release message that is obtained as part of box 3020 also includes the information described in connection with respect to box 3015; in other words, it would be possible that the configuration message of box 3015 is at least partly implemented by a connection release message that triggers the transition from the connected mode to the disconnected mode.

At box 3025, the UE optionally obtains a request for transmitting UL reference signals.

For instance, the request can be obtained from or triggered by a positioning server of the cellular NW such as the LMF 199. In other words, the request can trigger the UE to participate in a positioning procedure. In some examples, the request is obtained after transitioning to the disconnected mode at box 3020. In other examples, the request is obtained prior to transitioning to the disconnected mode; in such a scenario box 3025 is executed prior to box 3020.

At box 3030, the UE determines one or more TAs. This is based on timing measurements based on one or more DL reference signals transmitted by the cellular NW. In some examples, the UE performs timing measurements from multiple cells and determines the TA to match the UL timing of all these cells.

Box 3030 includes receiving one or more DL reference signals at box 3031. The one or more DL reference signals can be SSBs or positioning reference signals (PRSs).

The one or more DL reference signals can be transmitted by the cellular NW. They can be broadcasted.

Box 3030 further includes, at box 3032 calculating a propagation time of the one or more DL reference signals that are received at box 3031. Then, the TA is determined based on the calculated propagation time. The TA is determined to compensate for the delay introduced by the propagation time.

It would be possible to perform a validity check of the determined TA of box 3032. Box 3033 includes performing a comparison between the TA that is calculated at box 3032 and at least one of an allowed range of the TA, a reference TA, or candidate values of the TA. Such information can be obtained as part of box 3010 or as part of box 3015, as previously explained. Then, the previously determined TA of box 3032 can be discarded or maintained depending on that comparison. For instance, it can be checked whether the calculated TA of box 3032 is within the allowed range. If so, the determined TA is used for further purposes; else it is discarded. The candidate values of the TA are available, it would be possible to select the closest candidate value to the determined TA and use that as the TA for subsequent use.

It is possible that the validity check of the TA determined by the UE fails. I.e., the UE calculates a certain TA for one of one or more BSs and the corresponding TA does not fulfill one or more validity criteria. For instance, the determined TA may lie outside of a predefined range. In such a scenario, various options are possible. If the validity check fails, the UE may use the most-recent NW-provided TA for the respective BS. I.e., a fallback to a pre-configured TA obtained from the cellular NW would be possible. Alternatively, it would be possible that the UE performs a RACH procedure to obtain an update of the TA. The UE may not need to complete the random-access procedure, but about the random-access procedure upon obtaining the updated TA.

This is also described in connection with box 3034.

In a further scenario, at box 3034, the UE performs a random access procedure to obtain a reference TA from the cellular NW. Then, the UE can adjust this reference TA based on timing measurements that are executed based on the reference signals obtained at box 3031.

At box 3035, a transmit beam of transmitting of UL reference signals is determined. The transmit beam can be determined based on one or more DL reference signals. For instance, a DL reference signal burst can be received where multiple elements of the burst are associated with different transmit beams at the BS. Then, assuming general reciprocity, the transmit beam at the UE can be selected in accordance with the directionality of the DL reference signals.

At box 3045, the UE determines whether it is situated in the predefined spatial context. Depending on the definition of the spatial context, different checks can be executed at box 3045. For instance, the UE could monitor whether it receives a certain reference signal from the cellular NW. The UE may determine whether its latitude and longitude position is within the geo-fenced area. The UE may determine whether it can receive broadcasted information from certain cells included in a list of cell identities.

Upon determining that the UE is situated in the predefined spatial context, the UE transmits UL reference signals in accordance with the TA determined at box 3030, at box 3050. If the UE determines that it is not situated in the spatial context, a fallback option is executed at box 3055. In one example, the fallback option includes transmitting UL reference signals using the TA obtained as a reference at box 3010.

As will be appreciated from FIG. 4, the UE calculates, at box 3030, the TA based on the received reference signals from at least one cell, e.g., the serving cell and/or other cells. The UE performs timing measurement and use that for the TA of the UL transmission at box 3050.

Hence, the UE does not have to perform random access procedure to determine the TA at box 3030. The UE can determine the TA while operating in the disconnected mode. The UE may perform a RACH procedure at box 3034. The RACH procedure is aborted after receiving message 2. In this case, the self-calculated TA is used to adjust the TA value obtained in the legacy method.

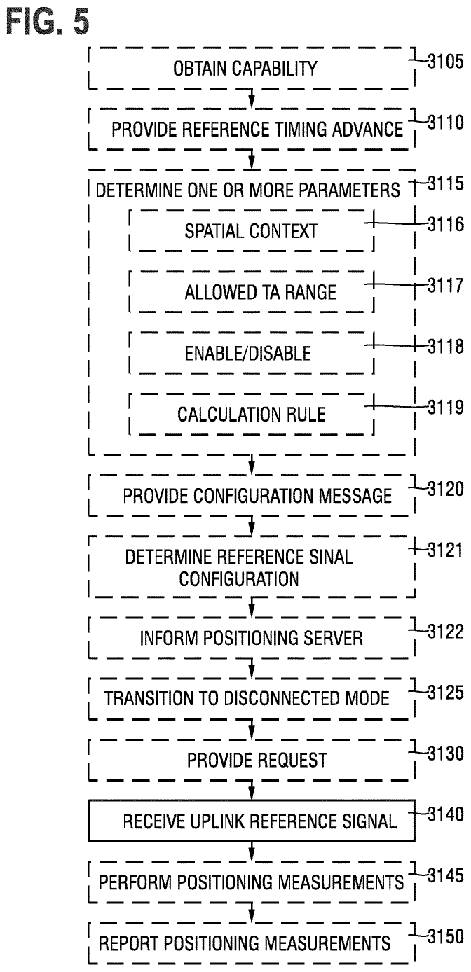

FIG. 5 is a flowchart of a method according to various examples. The method of FIG. 5 is for use in a BS of a cellular NW. The BS can connect to a UE. For example, the method of FIG. 5 can be used in the BS 112 or the BS 113. More specifically, the method of FIG. 5 can be executed by the processor 1121 upon loading and executing program code that is stored in the memory 1122.

Optional boxes are labeled with dashed lines.

At optional box 3105, the BS can obtain, from the UE, an indication that the UE is capable of determining the TA based on timing measurements of one or more DL reference signals that are transmitted by the radio access NW of the cellular NW while the UE operates in a disconnected mode. Box 3105 corresponds to box 3005 and details with respect to such capability message have already been discussed in connection with box 3005.

At optional box 3110, the BS provides a reference TA to the UE. Box 3110 corresponds to box 3010 and details have already been discussed in connection with box 3010.

At optional box 3115, the BS determines one or more parameters associated with the UE determining a TA for transmission of UL reference signals based on timing measurements on a DL reference signals that are transmitted by the radio access NW of the cellular NW.

The BS, at box 3115, can determine a spatial context in which the UE is allowed to determine the TA based on the timing measurements this is illustrated in box 3116.

For instance, at box 3116, the spatial context can be determined based on an application that is registered in association with the UE. This can be a positioning application. For instance, the application can pertain to asset tracking or monitoring of Internet of Things devices. The application can pertain to positioning in a factory environment. In other words, the application can set certain geographical constraints regarding the region within which positioning of the UE is required. Accordingly, the spatial context can be determined to cover that region. The spatial context can be determined to not extend beyond such required geographical constraints, to minimize interference.

The spatial context could also be pre-defined.

Alternatively or additionally, the BS, at box 3117, determines an allowed range of the TA. This determination can be based on extents of the spatial context. In particular, the BS can employ prior knowledge regarding the positioning of the BSs in the geographical region defined by the spatial context. This limits the maximum TA that can be observed by the UE moving within the constraints imposed by the spatial context. The allowed range can be set accordingly.

The allowed range could also be pre-defined.

Alternatively or additionally, at box 3118, the BS determines whether the UE is allowed to determine the TA based on the timing measurements based on the DL reference signals that are received by the UE while operating in the disconnected mode. In other words, the BS can determine whether to activate or deactivate such local TA calculation at the UE.

There are various options available for determining whether to enable or disable such determining of the TA locally at the UE. In particular, the BS can take into account whether the UE is capable of doing so, e.g., as indicated by the UE in box 3105. Alternatively or additionally, the BS can consider the application that is registered in association with the UE and that requires such positioning of the UE. For instance, such application may impose certain positioning latency constraints and/or power constraints for power consumption at the UE. Depending on whether such constraints require low-power low-latency positioning of the UE, the BS may either enable or disable determining of the TA locally at the UE. This limits local TA calculation to such scenarios where it is mandatory from application perspective; thereby limiting the interference risk.

At box 3119, the BS optionally determines a calculation rule for determining the TA based on timing measurements based on DL reference signals received by the UE while operating in the disconnected mode. Respective details with respect to possible calculation rules have been previously explained in connection with box 3015 in FIG. 4. For instance, the calculation can be determined in accordance and in conformity with the capability indicated by the UE at box 3105.

Furthermore, various parameters that can be indicated to the UE as part of the configuration message for determining the TA at box 3015 have been discussed at this occasion in connection with FIG. 4. All such parameters and further parameters can be determined by the BS at box 3115.

At box 3120, the BS then provides a configuration message or multiple configuration messages that are indicative of the one or more parameters determined at box 3115 to the UE. In some scenarios, the BS can report these parameters at least partly to a positioning server of the cellular NW such as the LMF 199; the positioning server can then forward these parameters to the UE.

Box 3120 corresponds to box 3015 of FIG. 4.

At box 3121, the BS determines a configuration of the UE transmitting reference signals. Various parameters of such configuration have already been previously discussed in connection with box 3016. The BS can determine the time-frequency resources for the transmission of the UL reference signals. The BS can then provide such configuration to the UE, e.g., via the LMF. This is illustrated in connection with box 3122.

As a general rule, it is possible to explicitly or implicitly inform the positioning server—at box 3122—that the UE and the BS support UE disconnected mode positioning. In other words, it is possible to provide, to the positioning server of the cellular NW, an indication that the BS (and optionally further BSs in the spatial context) support the UE operating in the disconnected mode to transmit the UL reference signals in accordance with a TA that is locally determined at the UE.

At box 3125, the UE transitions to the disconnected mode. This can include providing a connection release message to the UE. Box 3125 corresponds to box 3020 and respective details have been already discussed in this occasion.

It is optionally possible to provide a request for transmitting UL reference signals to the UE at box 3130. Details in this regard have already been discussed in connection with box 3025.

The BS then, at box 3140, receives UL reference signals that are transmitted by the UE. This is in accordance with the configuration determined at box 3120.

The BS at box 3145 performs positioning measurements. This includes, e.g., time difference of arrival and/or angle of arrival measurements.

Such positioning measurements can then be reported to the LMF at box 3150.

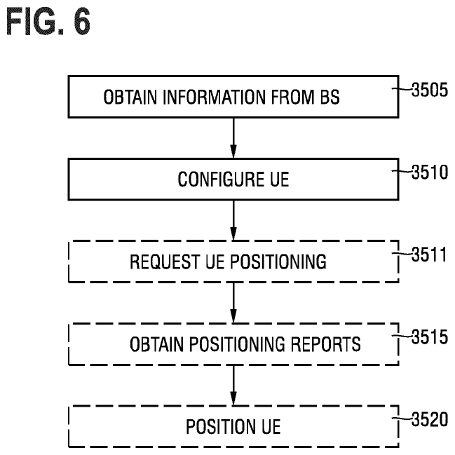

FIG. 6 is a flowchart of a method according to various examples. The method of FIG. 6 is for use in a positioning server of the cellular NW. The cellular NW includes a radio access NW including multiple BSs. The UE can connect to the cellular NW through the radio access NW. For example, the method of FIG. 6 can be used in the LMF 199. For example, the method of FIG. 6 can be executed by the processor 1991 upon loading and executing program code that is stored in the memory 1992.

Optional boxes are labeled with dashed lines.

The location server, at box 3505, obtains an indication of one or more BSs of the radio access NW of the cellular NW supporting a UE operating in the disconnected mode to transmit UL reference signals in accordance with a TA that is determined by the UE based on timing measurements executed at the UE based on DL reference signals. The DL RSs are transmitted while the UE operates in the disconnected mode. Box 3505 corresponds to box 3122.

The location server optionally, at box 3505, obtains a configuration for transmitting the UL reference signals for each one of the multiple BSs. Certain parameters can be shared amongst the multiple BSs.

For instance, the time-frequency resources to be used by the UE for transmitting the UL reference signals can be indicated. A numerology can be indicated. A repetition rate of the time-frequency resources that are reoccurring over time can be indicated.

Then, the location server, at box 3510, configures the UE to transmit the UL reference signals when the UE operates in the disconnected mode. This can include providing the configuration of transmitting the UL reference signals to the UE, as obtained at box 3505.

At optional box 3511, the location server can request the UE to be positioned. In particular, the location server can provide, to the radio access NW of the cellular NW, a command to reach the UE so that the UE starts transmitting the UL reference signals based on which the positioning is implemented. This can occur while the UE is operating in the idle mode. Then, a paging or wake up procedure can be used to deliver the request to the UE. Also see box 3025.

The request of box 3511 can be provided responsive to a need for positioning the UE. For instance, an application associated with the UE—e.g., an asset tracking application—can request the location server to provide an update of the position of the UE.

At box 3515, the positioning server obtains one or more positioning measurement reports from one or more BSs. These one or more positioning measurement reports are based on the respective one or more BSs receiving the UL reference signals from the UE in performing positioning measurements based on the UL reference signals that are received from the UE. Box 3515 corresponds to box 3145.

The positioning server then can position the UE based on the positioning measurement reports obtained at box 3515.

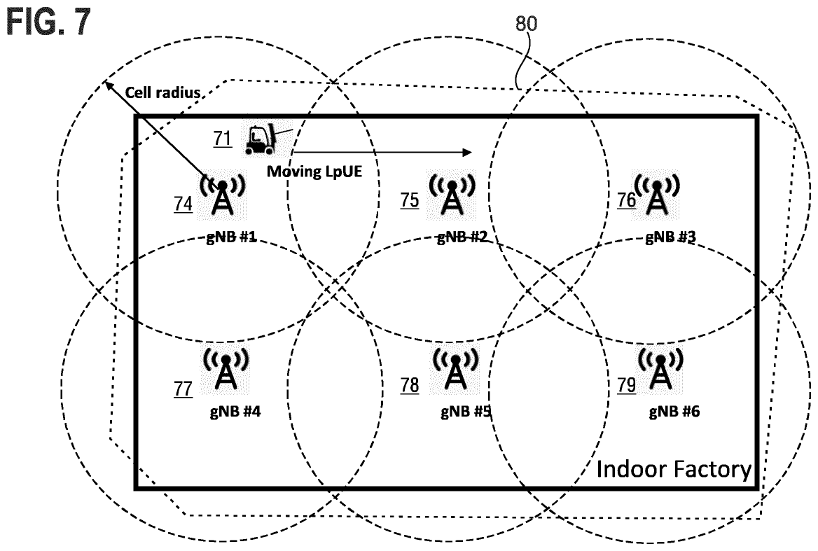

FIG. 7 illustrates a deployment scenario according to various examples. FIG. 7 illustrates a low-power high-accuracy positioning (LPHAP) use case in, for example, a factory. High accuracy positioning is likely to become important for factories in the future e.g., see 3GPP TS 22.104, version 17.7.0, section 5.1.

A UE 71 supporting LPHAP (LpUE 71) will require a significantly lower power consumption compared to legacy UEs in 3GPP NR. However, there can be some limitations. One of the potential use-cases of an LpUE is to be operated in a factory/warehouse as illustrated in FIG. 7 with a certain number of BSs 74-79. The position of the LpUE 71 needs to be tracked for certain purposes, such as factory automation, tracking, logistics, etc. The LpUE 71 is expected to have a mobility function within the factory/warehouse. Hence, it will interact with the BSs 74-76. This is illustrated in FIG. 7. Here, the LpUE 71 supports mobility with a limited number of BSs 74-79.

Once the LpUE 71 is outside the factory then the LpUE 71 no longer can utilize the low power capability or may not be operated at all.

Accordingly, a spatial context 80 is defined. The spatial context 80 covers the indoor factory floor. The spatial context 80 corresponds to a geographical area. In FIG. 7, a respective spatial context 80 is illustrated using the dotted line.

Various options are available for defining the spatial context 80. For instance, the spatial context 80 can be defined by a geofenced area. Alternatively or additionally, the spatial context 80 can be defined by the coverage of all BS 74-79; a respective cell identity list can be used to define the spatial context 80.

Within the spatial context 80, the UE is allowed to perform local calculation of its TA towards each BS.

In the deployment scenario of FIG. 7, the LpUE 71 is able to transmit UL RSs for positioning purposes to the BS 74-79. Each BS 74-79 performs positioning measurements, such as time difference of arrival or angle of arrival measurements. The positioning measurements results are transmitted to a location server such as the LMF 199. The LMF 199 performs a positioning estimation based on the obtained positioning measurements and the geographical position of the BSs 74-79. This positioning estimation is in accordance with prior art techniques.

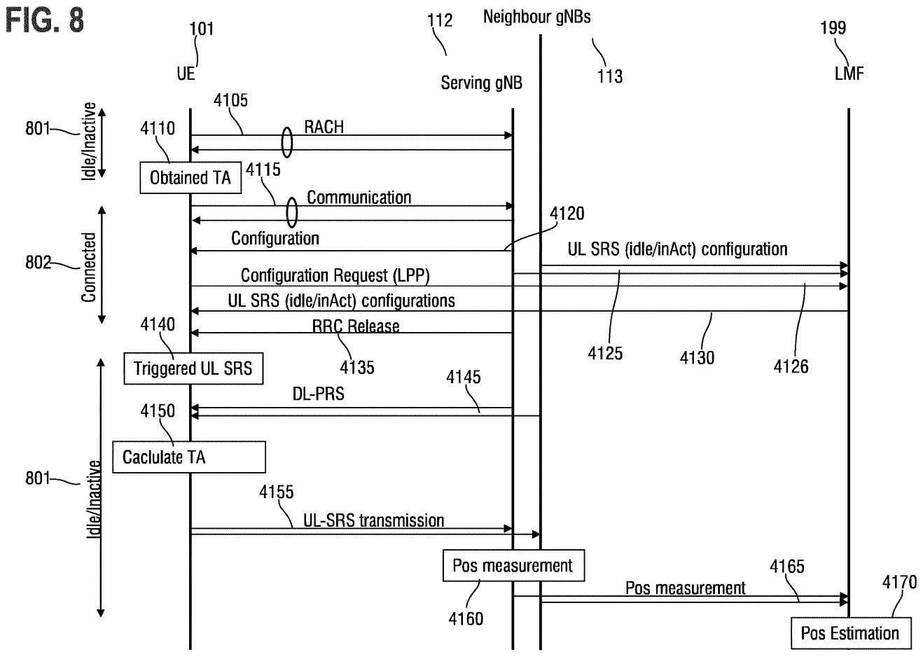

FIG. 8 is a signaling diagram of communication between the UE 101, the BSs 112, 113 and the LMF 199. When the UE is operating in the disconnected mode 801, the UE 101 can be triggered to perform UL SRS transmission. The UE will check and may need to update the TA.

Hence, the UE performs timing measurement first using DL-PRS or SSB. The UE updates its TA, if needed, and starts transmitting UL SRS based on the preconfigured UL-SRS configuration. The remaining positioning measurement and positioning estimation are following the legacy procedure. This procedure is now explained in further detail.

First, the UE 101 synchronizes with the cellular NW 100 while operating in the disconnected mode 801. SSBs are received for this purpose.

The UE 101 initiates and participates, at 4105, in a RACH procedure. As part of the DL message of the RACH procedure it obtains the reference TA, box 4110. The serving BS 112 performs a timing measurement on the RACH preamble transmitted by the UE and then determines the reference TA and includes the reference TA in the RACH message 2 sent in response to the RACH preamble.

The UE 101 transitions to the RRC_Connected mode 802 and, at 4115, performs a communication exchange. This can include indicating the UE capability (details have been explained in box 3005). RRC configuration and payload data can be communicated. The capability can be included in an RRC control message communicated on a Physical Shared UL Channel (PUSCH).

At 4120 the serving BS 112 provides configuration for determining the TA locally. Details have been explained in connection with box 3015.

At 4125, the BSs 112, 113 provide the UL SRS configuration to the LMF 199. The BSs 112, 113 thus inform the LMF 199 of the time-frequency resources to be used, etc.

The message communicated at 4125 can, in some scenarios, indicate to the LMF 199 that the UE 101 and the BSs 112, 113 support positioning the UE 101 while the UE 101 operates in the disconnected mode. The message communicated at 4125 can, in particular, inform the LMF 199 that the UE 101 within the coverage of BSs 112, 113 can be allowed to determine the TA locally. One or more of the BSs may not allow the UE 101 to determine the TA locally. Hence, the UE 101 needs to use the legacy procedure for the obtaining TA and performing the subsequent UL SRS transmission. Alternatively, one or more of the BSs may allow the UE 101 to determine the TA locally. Hence, the UE 101 uses the locally determined TA prior to the UL SRS transmission. See box 3122.

The UE 101, at 4126, provides a configuration request message to the LMF 199. The configuration request message requests provisioning with an UL SRS configuration for transmitting UL SRS towards the BSs 112, 113 when operating in the disconnected mode 801. The configuration request message is optional. The LMF 199 may also proactively provide the UL SRS con-figuration.

The LMF 199 provides, at 4130, the UL SRS configuration for all BSs 112, 113 in a respective spatial context. These BSs all support the UE locally determining the TA. The spatial context excludes such BS that do not allow the UE locally determining the TA. The respective message implements a request for transmitting UL SRS while the UE 101 operates in the disconnected mode 801 (cf. box 3025). This configuration message can be implemented in accordance with the LPP protocol, see 3GPP TS 38.305, version 17.2.0, section 8.13. Respective aspects have been discussed in connection with box 3016 in connection with FIG. 4.

Then, the serving BS 112 provides an RRC connection release message at 4135 to the UE 101; the UE 101 accordingly transitions to operating in the disconnected mode 801.Cf. box 3020.

At box 4140, the UE is triggered to transmit UL SRS. Various trigger criteria are possible. For instance, a request for transmitting the UL reference signals can be obtained from the cellular NW—e.g., the LMF 199—while operating in the disconnected mode, as previously explained in connection with box 3025 and box 3511.

Alternatively or additionally, local trigger criteria that the UE would be conceivable, e.g., a pre-defined timing schedule, detecting UE mobility, a mobility level above a certain threshold, a signal from an acceleration sensor, etc.

Then, the UE monitors for DL reference signals, here DL positioning reference signals at 4145. This has been previously discussed in connection with box 3030 and box 3031.

The UE then determines the TA at box 4150 based on timing measurements that are based on the received DL positioning reference signals received at 4145. Respective techniques have been previously discussed in connection with box 3030 and specifically 3032.

Different options are available for determining the TA, e.g., based on a combination of the calculated TA that is based on the timing measurements based on the DL PRS received at 4145 as well as the reference TA obtained at 4110.

Then, at 4155, the UE transmits UL sounding reference signals based on the configuration obtained at 4130 and employing the TA determined at 4150.

The BSs 112, 113 perform positioning measurements at 4160 and report the positioning measurements by providing respective positioning measurement report messages at 4165 to the LMF 199. This corresponds to boxes 3145, 3150, 3515.

At 4170 the LMF 199 performs a position estimation. Respective techniques are disclosed in 3GPP TS 38.305, version 17.2.0, section 4.3.14. This corresponds to box 3520.

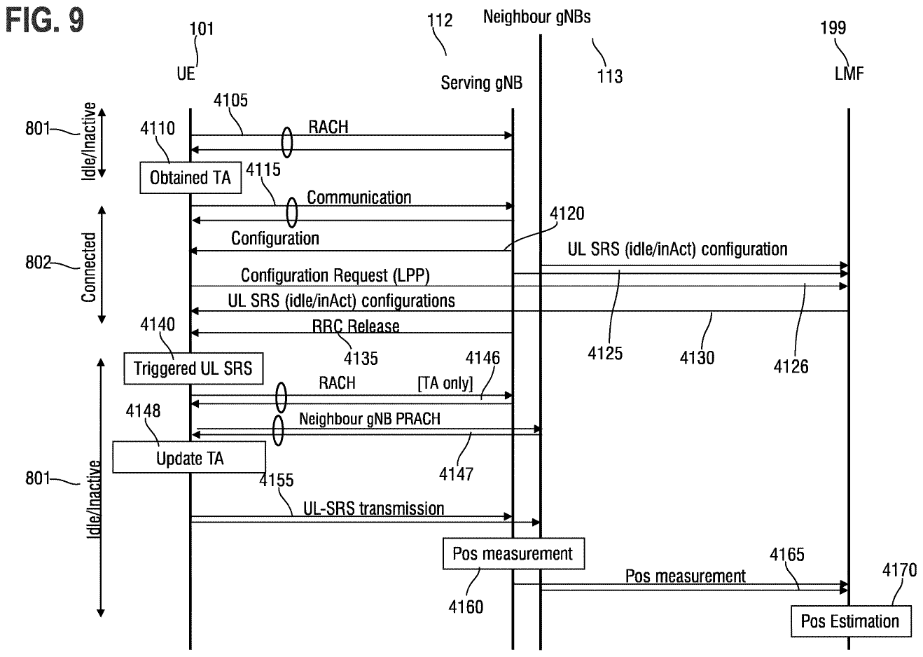

FIG. 9 is a signaling diagram of communication between the UE 101, the BSs 112, 113, and the LMF 199. FIG. 9 is an alternative implementation of the UE operation in the disconnected mode 801.

The signaling of FIG. 9 generally corresponds to the signaling of FIG. 8. However, FIG. 9 is modified regarding the process of the UE 101 obtaining the TA. In particular, in FIG. 9, the UE does not monitor for DL positioning reference signals as in FIG. 8. Rather, the UE performs, at 4146 and 4147, transmissions of random-access preambles to the BSs 112, 113, respectively. The BSs 112, 130 and then responds with the random-access message 2, respectively, and each of these random access message 2 includes a corresponding TA for the BS 112 and the BS 113, respectively. The UE does not continue the RACH procedure; but rather updates its TA at 4148 for each of the BSs 112, 113 and, as already explained above in connection with FIG. 8, then transmits UL SRS at 4155 using these TA for each of the BSs 112, 113.

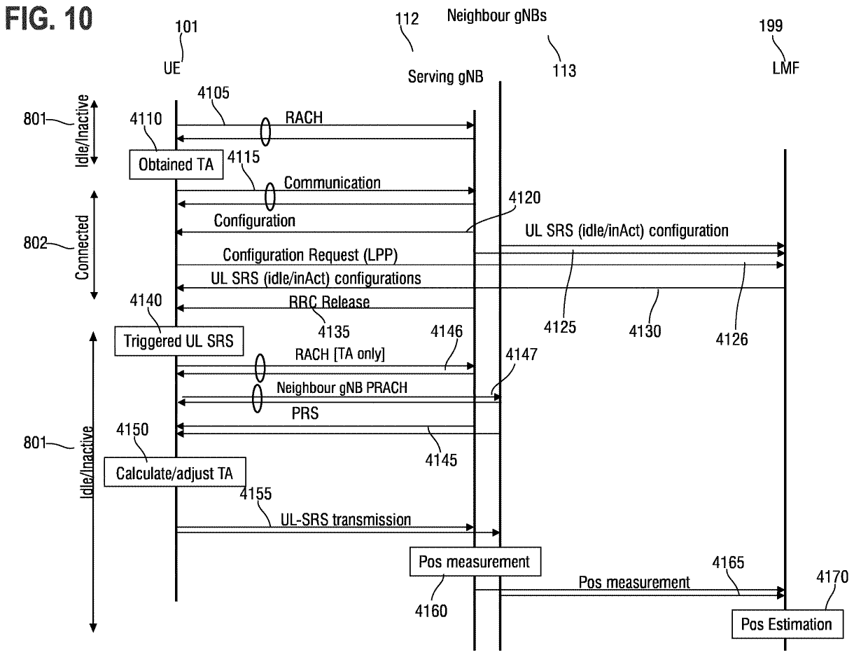

FIG. 10 is a signaling diagram of communication between the UE 101, the BSs 112, 113, and the LMF 199. FIG. 10 is a combination of the implementations of FIG. 8 and FIG. 9. Specifically, the UE performs attach procedures at 4146, 4147 towards the BSs 112, 113; respectively obtain the TA for each of the BSs 112, 113 as a reference. Then, this TA is used as a reference for determining the TA at 4150 based on timing measurements implemented on positioning reference signals that are received-typically at some later point in time-at 4145. In other words, in the scenario of FIG. 10, the UE performs the random-access procedure to obtain the reference TA and adjust the reference TA based on timing measurements implemented on the positioning reference signals. Such scenario is explained in connection with box 3034.

Summarizing, techniques have been disclosed that enable pre-configuration of a valid area for UL transmission of RSs by a UE while the UE operates in a disconnected mode. The valid area defines a spatial context. The UE self-calculates the TA used for the UL transmission.

The UE can either fully calculate the TA (e.g., ab initio without a reference) or adjust a pre-obtained reference TA.

The calculation of the TA has been shown to be guided and assisted by the cellular NW. For instance, a calculation rule and/or constraints for the TA can be provided.

The cellular NW can also pre-configure the UL transmission of the RSs. This can include spatial direction, i.e., beam direction, for the UL transmission.

According to the disclosed techniques, the communicated required to acquiring of the TA is minimized.

Various scenarios of the disclosure are based on the finding that operating the UE in the connected mode consumes significant power consumption. It is preferable for the UE to be able to start UL reference signal transmission and also receiving the configuration when the UE is in disconnected mode. However, when the UE is in disconnected mode, there are challenges in obtaining TA and the configuration of reference signal (e.g., time and resource of SRS transmission).

Techniques have been disclosed to allow obtaining TA information and the configuration of reference signal without the UE entering the connected mode.

Summarizing, at least the following EXAMPLES have been disclosed.
EXAMPLE 1. A method for use in a wireless communication device (71, 101) connectable to a cellular network (100), the method comprising:
while operating in a disconnected mode (801), determining a timing advance for facilitating communication with each of one or more base stations (74-79, 112, 113) of the cellular network (100) based on timing measurements on one or more downlink reference signals (4145) transmitted by each of the one or more base stations, and
upon determining that the wireless communication device (71, 101) is situated in a predefined spatial context (80) and while operating in the disconnected mode: transmitting uplink reference signals (4155) in accordance with the timing advance in preconfigured time-frequency resources.
EXAMPLE 2. The method of EXAMPLE 1,
   wherein the preconfigured time-frequency resources are allocated for positioning of the wireless communication device.
EXAMPLE 3. The method of EXAMPLE 1 or 2, further comprising:
obtaining (3025), from the cellular network, a request for transmitting the uplink reference signals while operating in the disconnected mode.
EXAMPLE 4. The method of any one of the preceding EXAMPLEs,
wherein the predefined spatial context is defined by the wireless communication device being located in one or more cells of the cellular network.
EXAMPLE 5. The method of any one of the preceding EXAMPLEs, further comprising:
obtaining (3015), from the cellular network, at least one configuration message associated with said determining of the timing advance.
EXAMPLE 6. The method of EXAMPLE 5,
   wherein the at least one configuration message associated with said determining of the timing advance is indicative of the spatial context.
EXAMPLE 7. The method of any one of the preceding EXAMPLEs, further comprising:
obtaining (3010), from the cellular network, at least one of an allowed range of the timing advance, a reference timing advance, or candidate values of the timing advance
EXAMPLE 8. The method of any one of the preceding EXAMPLEs,
obtaining, from the cellular network, at least one configuration message associated with said transmitting of the uplink reference signals.
EXAMPLE 9. The method of EXAMPLE 8,
   wherein the at least one configuration message associated with said transmitting of the uplink reference signals is at least partly provided by a positioning server (199) of the cellular network.
EXAMPLE 10. The method of EXAMPLE 8 or 9,
wherein the at least one configuration message associated with said transmitting of the uplink reference signals is indicative of the preconfigured time-frequency resources.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, above, various scenarios have been disclosed in connection with the UE transmitting uplink reference signals for the purpose of positioning the UE. In other scenarios, the UE transmits uplink reference signals for other purposes, e.g., channel sounding. The techniques disclosed herein for determining the timing advance while operating in the disconnected mode are not limited to positioning of the UE.

1. A method for use in a wireless communication device connectable to a cellular network, the method comprising:
while operating in a disconnected mode, determining a timing advance for facilitating communication with each of one or more base stations of the cellular network based on timing measurements on one or more downlink reference signals transmitted by each of the one or more base stations, and
upon determining that the wireless communication device is situated in a predefined spatial context and while operating in the disconnected mode: transmitting one or more uplink reference signals in accordance with the timing advance in preconfigured time-frequency resources.

2. The method of claim 1,
wherein the preconfigured time-frequency resources are allocated for positioning of the wireless communication device.

3. The method of claim 1, further comprising:
obtaining, from the cellular network, a request for transmitting the one or more uplink reference signals while operating in the disconnected mode.

4. The method of claim 3,
wherein the request is obtained prior to transitioning to the disconnected mode.

5. The method of claim 3,
wherein the request is obtained while operating in the disconnected mode.

6. The method of claim 1,
wherein the one or more uplink reference signals are uplink positioning reference signals.

7. The method of claim 1,
wherein the predefined spatial context is defined by the wireless communication device being located in one or more cells of the cellular network.

8. The method of claim 1,
wherein the predefined spatial context is defined by the wireless communication device being located in a geofenced area.

9. The method of claim 1,
wherein the predefined spatial context is defined by the wireless communication device receiving predefined reference signals.

10. The method of claim 1, further comprising:
obtaining, from the cellular network, at least one configuration message associated with said determining of the timing advance.

11. The method of claim 10,
wherein the at least one configuration message associated with said determining of the timing advance is provided by a radio-access network of the cellular network.

12. The method of claim 10,
wherein the at least one configuration message associated with said determining of the timing advance is indicative of the predefined spatial context.

13. The method of claim 12,
wherein the predefined spatial context is defined by the wireless communication device being located in one or more cells of the cellular network,
wherein the at least one configuration message comprises a cell list of cell identities of cells of the cellular network defining the predefined spatial context.

14. The method of claim 10,
wherein the at least one configuration message associated with said determining of the timing advance is indicative of whether the wireless communication device is allowed to employ the timing advance determined based on the timing measurements.

15. The method of claim 10,
wherein the at least one configuration message associated with said determining of the timing advance is indicative of a calculation rule for determining the timing advance based on the timing measurements.

16. The method of claim 10,
wherein the at least one configuration message associated with said determining of the timing advance is indicative of a type of the one or more downlink reference signals.

17. The method of claim 1, further comprising:
obtaining, from the cellular network, at least one of an allowed range of the timing advance, a reference timing advance, or candidate values of the timing advance.

18. The method of claim 1,
wherein a type of the one or more downlink reference signals is at least one of a synchronization signal block or a positioning reference signal.

19. The method of claim 1,
obtaining, from the cellular network, at least one configuration message associated with said transmitting of the one or more uplink reference signals.

20-29. (canceled)

30. A method for use in a node of a cellular network, the method comprising:
providing at least one configuration message to a wireless communication device, the at least one configuration message being associated with the wireless communication device determining a timing advance for a transmission of one or more uplink reference signals based on timing measurements based on downlink reference signals transmitted by one or more base stations of the cellular network, and
triggering the one or more base station to monitor for the one or more uplink reference signals transmitted by the wireless communication device while operating in a disconnected mode.

31-53. (canceled)
